(19) United States
(12) Patent Application Publication
(10) Pub. No.: US 2013/0108241 A1
(43) Pub. Date: May 2, 2013

(54) INFORMATION PROCESSING DEVICE, INFORMATION PROCESSING METHOD, PROGRAM, RECORDING MEDIUM, AND INTEGRATED CIRCUIT

(71) Applicants: Shingo Miyamoto, Hyogo (JP); Masaya Yamamoto, Kanagawa (JP); Ryota Tsukidate, Osaka (JP); Ryuji Inoue, Osaka (JP)

(72) Inventors: Shingo Miyamoto, Hyogo (JP); Masaya Yamamoto, Kanagawa (JP); Ryota Tsukidate, Osaka (JP); Ryuji Inoue, Osaka (JP)

(73) Assignee: Panasonic Corporation, Osaka (JP)

(21) Appl. No.: 13/809,008

(22) PCT Filed: May 11, 2012
(86) PCT No.: PCT/JP2012/003102

§ 371 Date: Jan. 8, 2013

(30) Foreign Application Priority Data
May 23, 2011 (JP) 2011-114511

(51) Int. Cl. H04N 9/87

(52) U.S. Cl. 386/241

(57) ABSTRACT

An information processing device is provided with a specification unit that specifies a plurality of playback positions in a video content, an extraction unit that extracts, in accordance with the specified playback positions, a plurality of scenes each including at least one of the specified playback positions and each indicating a section of the video content, and a provision unit that provides priority to each of the extracted scenes.

### TECHNICAL FIELD

The present invention relates to technology for supporting creation of a highlight video from video content.

### BACKGROUND ART

To facilitate efficient viewing by users, conventional technology exists for supporting the extraction of scenes that are highlights from among original video content (for example, see Patent Literature 1 through 4).

### CITATION LIST

### Patent Literature

Patent Literature 1: Japanese Patent Application Publication No. 2008-98719

Patent Literature 2: Japanese Patent Application Publication No. 2007-134770

Patent Literature 3: Japanese Patent Application Publication No. 2000-235637

Patent Literature 4: Japanese Patent Application Publication No. H6-165009

### SUMMARY OF INVENTION

### Technical Problem

In order to create a highlight video, it is necessary to extract appropriate portions from an original video content.

It is an object of the present invention to provide an information processing device that can contribute to the creation of a superior highlight video.

### Solution to Problem

An information processing device according to the present invention comprises a specification unit configured to specify a plurality of playback positions in a video content; an extraction unit configured to extract, in accordance with the specified playback positions, a plurality of scenes each including at least one of the specified playback positions and each indicating a section of the video content; and a provision unit configured to provide a degree of priority to each of the extracted scenes.

### Advantageous Effects of Invention

The information processing device according to the present invention contributes to the creation of a superior highlight video.

### BRIEF DESCRIPTION OF DRAWINGS

FIG. 1 shows the structure of an information processing device according to Embodiment 1.

FIG. 2 shows the data structure of metadata for a mark.

FIG. 3 is a flowchart of overall operations for highlight video creation.

FIG. 4 is a flowchart of operations for a mark input step.

FIG. 5 shows an example of the user inputting marks.

FIG. 6 is a flowchart of operations for a highlight scene extraction step.

FIGS. 7A and 7B show an example of extracting a highlight scene based on marks.

FIG. 8 is a flowchart of operations for a highlight scene priority degree providing step.

FIG. 9 shows an example of providing a degree of priority based on the length of the playback section of highlight scenes.

FIG. 10 shows an example of providing a degree of priority based on the density of marks in highlight scenes.

FIG. 11 is a flowchart of operations for a highlight scene length adjustment step.

FIG. 12 is an example of creating a highlight video after shortening the length of the playback section of a highlight scene with a low a degree of priority.

FIG. 13 shows the structure of an information processing device according to Embodiment 2.

FIG. 14 is a flowchart of operations for the highlight scene extraction step.

FIG. 15 shows an example of the highlight scene extraction step.

FIG. 16 is a flowchart of operations for the highlight scene priority degree providing step.

FIGS. 17A and 17B show separation into cases based on the length of the playback section of a highlight scene and the total of the length of the playback sections of the highlight scenes in one shot.

FIG. 18 shows the relationship between a plurality of highlight scenes in one shot.

FIG. 19 illustrates the provision of a degree of priority when the total of the length of the playback sections of the highlight scenes in one shot is equal to or less than T1.

FIG. 20 illustrates the degree of priority when the total of the length of the playback sections of the highlight scenes in one shot is equal to or less than T2.

FIG. 21 illustrates the degree of priority when the total of the length of the playback sections of the highlight scenes in one shot is greater than T2.

FIG. 22 shows an example of providing degrees of priority using a remote control.

FIG. 23 shows the structure of an information processing device according to Embodiment 3.

FIG. 24 shows an example of indices used for providing marks.

FIG. 25 shows the structure of an information processing device according to Embodiment 4.

FIG. 26 shows the structural outline of an information processing device.

### DESCRIPTION OF EMBODIMENTS

### Discovery Leading to the Present Embodiment

The inventors examined the issue of creating a highlight video by connecting scenes extracted either based on user instruction or automatically.

Users are not always satisfied with a highlight video created by simply connecting extracted scenes, however, as the video may be too short to understand, or may be so long as to be redundant.

The present embodiment was conceived in light of this background, and it is an object thereof to adjust the length of each scene to an appropriate length mainly for the creation of a highlight video.

The following describes embodiments of the present invention with reference to the drawings.

### Embodiment 1

### Structure of Information Processing Device

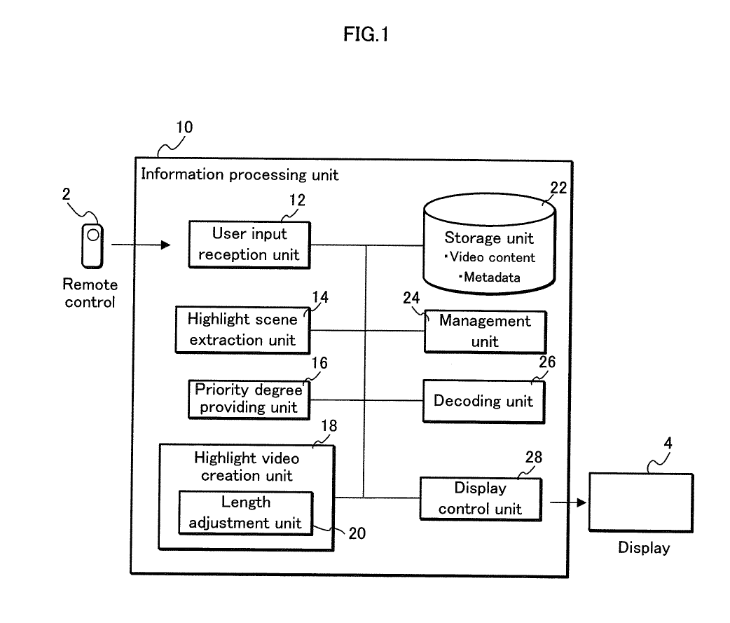

FIG. 1 shows the structure of an information processing device 10 according to Embodiment 1.

The information processing device 10 is provided with a user input reception unit 12, a highlight scene extraction unit 14, a priority degree providing unit 16, a highlight video creation unit 18 (including a length adjustment unit 20), a storage unit 22, a management unit 24, a decoding unit 26, and a display control unit 28.

The user input reception unit 12 has a function to receive user input via a remote control 2.

The remote control 2 includes a plurality of buttons for indicating playback of a video (start playback, stop playback, skip, fast-forward, rewind, and the like), as well as a button by which a user indicates the desire to include a scene in a highlight video.

The method by which the user indicates such a scene may be to manually indicate the start and the end of the scene, or to indicate a portion of the scene.

The present embodiment describes the case in which the user indicates a portion of the scene. Specifically, when finding a scene interesting, the user inputs a “mark” by pressing the button for indicating the desire to include the scene in the highlight video. This mark is composed of information for identifying the video that the user found interesting and a corresponding playback position.

As described above, this mark may be indicated by the user, or may be automatically indicated when the information processing device 10 or another device analyzes the video. In Embodiment 1, an example is described in which the mark is indicated by the user.

When a button in the remote control 2 is pressed, the remote control 2 transmits information to the user input reception unit 12 indicating the content of the user instruction.

The user input reception unit 12 receives, as user input, the content of the instruction indicated in the received information.

The highlight scene extraction unit 14 extracts a highlight scene, based on the mark, from among video content stored in the storage unit 22. This highlight scene is either a scene that the user likes or a scene that the user is predicted to like.

As necessary, the priority degree providing unit 16 provides a degree of priority to each highlight scene extracted by the highlight scene extraction unit 14.

The highlight video creation unit 18 creates a highlight video by connecting extracted highlight scenes.

The length adjustment unit 20 determines whether the length of the highlight video created by connecting highlight scenes is optimal, and when not optimal, adjusts the length of the highlight video by requesting that the highlight scene extraction unit 14 re-extract a highlight scene so as to have a different length.

Details on extraction of highlight scenes, provision of degrees of priority, and creation of a highlight video are provided below.

The storage unit 22 is composed, for example, of a Hard Disk Drive (HDD) or the like and stores video content and metadata.

The video content is not particularly limited. It suffices for the video content to have a certain length in order to be the target of highlight scene extraction. The example of video content described in the present embodiment is user-created content the user has created by filming. This example is used because users often wish to create highlight videos for such user-created content, since redundant scenes are prevalent in such content.

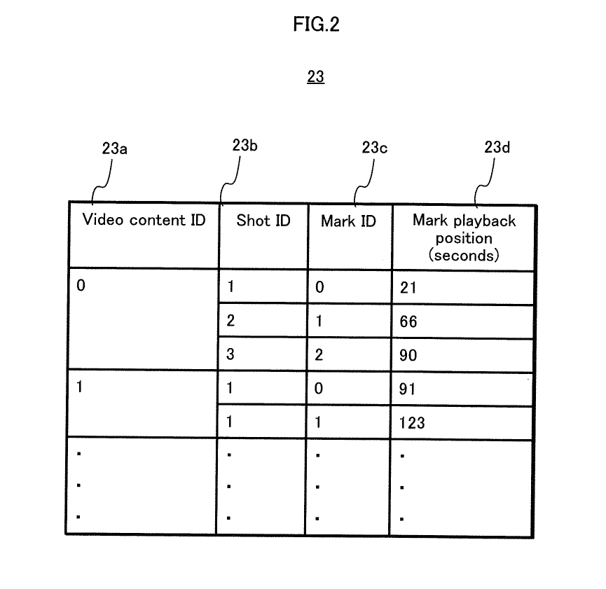

FIG. 2 is an example of metadata stored by the storage unit 22.

Table 23 in FIG. 2 shows the structure of metadata and includes a “video content ID” 23a, a “shot ID” 23b, a “mark ID” 23c, and a “mark playback position (seconds)” 23d.

The “video content ID” 23a is an identifier for uniquely identifying a video content stored in the storage unit 22.

The “shot ID” 23b is an identifier for identifying one or more shots corresponding to the video content indicated by the “video content ID” 23a. In this context, a “shot” is a unit from the start to the end of one filming session during the filming of a user video.

The “mark ID” 23c is an identifier for identifying a mark.

The “mark playback position (seconds)” 23d indicates the playback position corresponding to the mark ID. Note that it suffices for this information to indicate a playback position. For example, instead of the number of seconds, a frame ID in the video may be used.

The management unit 24 has a function to manage metadata and playback of video content.

Specifically, when the user input reception unit 12 receives an instruction to play back a video, then based on this instruction, the management unit 24 causes the decoding unit 26 to decode the video content stored in the storage unit 22. The management unit 24 then displays the decoded video content on a display 4 via the display control unit 28.

When the user input reception unit 12 receives input from the user of a mark during playback of the video content, the management unit 24 stores the video content ID, the playback position, and the like for the video content that was being played back when the mark was received. The management unit 24 stores this information as metadata in the storage unit 22.

Note that the metadata shown in FIG. 2 is only an example, and metadata is not limited in this way. For example, the video content to which shots belong may be managed by a separate playlist or the like.

### Overall Operations for Highlight Video Creation

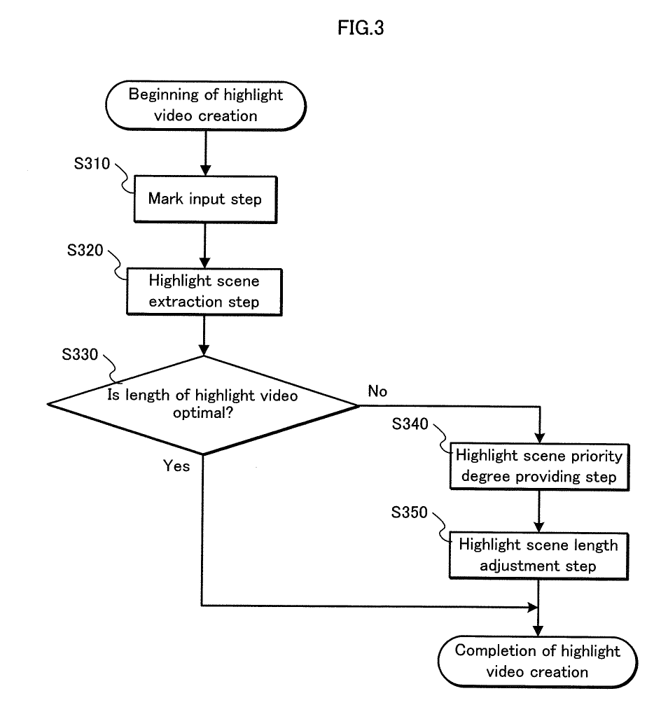

Next, overall operations for highlight video creation in the information processing device 10 of Embodiment 1 are described with reference to FIG. 3.

A mark input step (S310) is first performed with the information processing device 10.

Next, the information processing device 10 performs a highlight scene extraction step (S320) to extract highlight scenes based on the playback positions of the marks received by the user input.

The information processing device 10 then performs a determination step (S330) to determine whether the length of the highlight video yielded by connecting the highlight scenes extracted during the highlight scene extraction step (S320) is optimal.

When determining that the length of the highlight video is not optimal (S330: No), the information processing device 10 performs a highlight scene priority degree providing step (S340) to provide a degree of priority to each highlight scene extracted in step S320, as well as a highlight scene length adjustment step (S350) to adjust the length of the playback section of each highlight scene based on the provided degree of priority.

Note that an optimal length for the highlight video in step S330 is, for example, when the length of the highlight video yielded by connecting highlight scenes as extracted in step S320 lies between a predetermined lower limit and a predetermined upper limit (such as between 5 minutes and 15 minutes).

### Mark Input Step

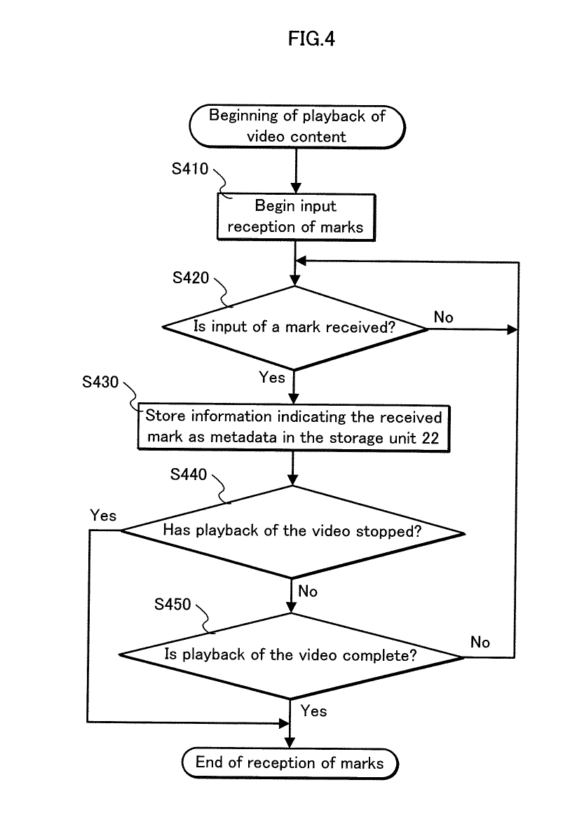

First, details on the mark input step (S310) are described with reference to FIG. 4.

First, when the management unit 24 causes playback of the video content to begin, the user input reception unit 12 begins reception of user input of marks (S410) and waits for input (S420: No).

Upon receiving input of a mark (S420: Yes), the user input reception unit 12 stores information constituting the received mark as metadata in the storage unit 22 (S430). In the case of the example in FIG. 2, the information constituting the received mark includes the video content ID, the shot ID, the mark ID, and the mark playback position.

Note that the mark playback position to be stored as metadata may be a playback position corresponding to the frame being decoded by the decoding unit 26 at the point the mark is received, or may be a playback position corresponding to the frame that is being read by the management unit 24 at the point the mark is received.

The processing in steps S420 and S430 is repeated until the user input reception unit 12 receives an instruction to stop playback of the video content (S440) or until playback reaches the end of the video content (S450).

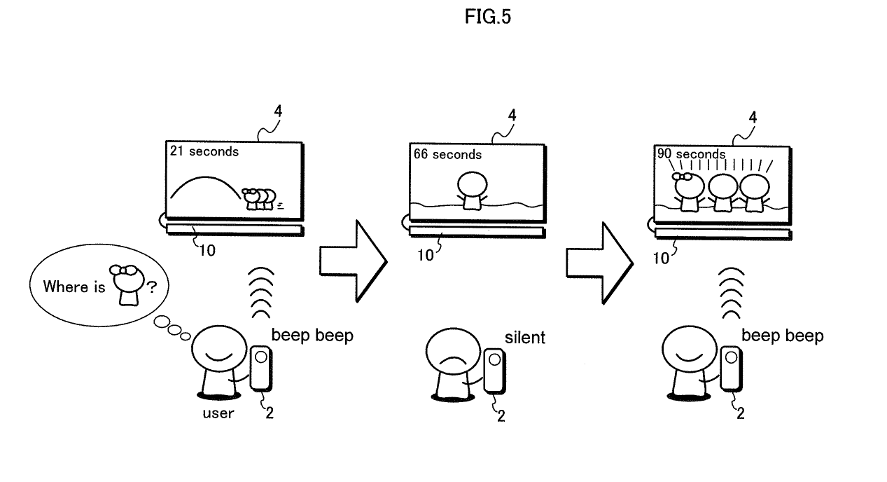

FIG. 5 shows an example of the user inputting marks.

In the example in FIG. 5, the user is viewing a video content that he filmed himself of his daughter dancing at kindergarten on Parent's Day. Since the user wants to see his daughter, he presses the highlight button on the remote control 2 when his daughter appears.

### Highlight Scene Extraction Step

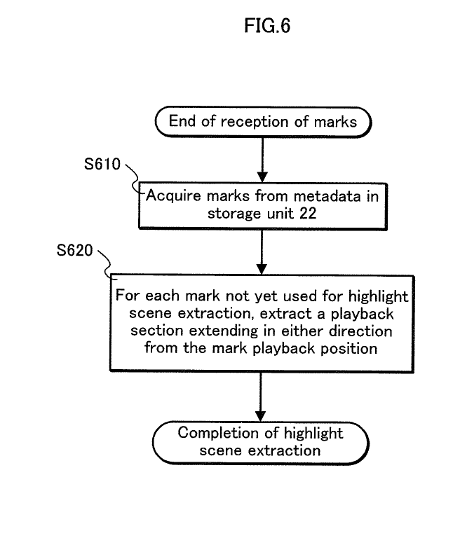

Next, details on the highlight scene extraction step (S320) are provided with reference to FIG. 6.

When the mark input step (S310) is complete, the management unit 24 notifies the highlight scene extraction unit 14 of completion of the mark input step.

Upon receiving this notification, the highlight scene extraction unit 14 acquires, from among metadata stored in the storage unit 22, the marks associated with the video content that was being played back immediately before completion of the mark input step (S610).

For example, if the metadata is structured as in the example in FIG. 2, and the ID of the video content being played back immediately before completion is 0, the highlight scene extraction unit 14 acquires three lines of the metadata starting from the top of the table in FIG. 2.

Next, the highlight scene extraction unit 14 extracts a playback section for each mark for which the corresponding highlight scene has not been extracted (S620). The playback section extends in either direction from the mark playback position.

A variety of methods are possible as the extraction method in step S620. For example, one method is to extract a fixed-length scene based on the mark as a highlight scene.

With this method, the playback section extending for a set fixed length in either direction from the mark playback position is extracted as a highlight scene. Furthermore, with this method, when the difference between the playback positions of the plurality of marks is smaller than the fixed length, the highlight scenes extracted for the plurality of marks overlap. In this case, the playback section that extends from a point that is the fixed length before the first mark until a point that is the fixed length after the last mark is extracted as a highlight scene.

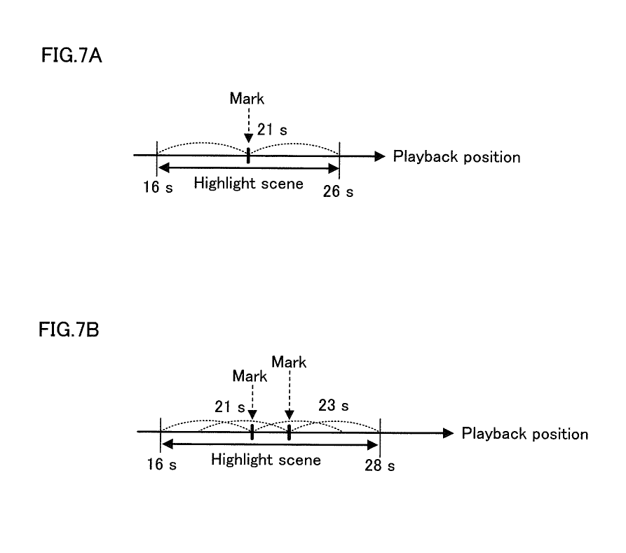

FIGS. 7A and 7B show an example of this method when the fixed length is 5 seconds. In FIG. 7A, the mark playback position is 21 seconds, and therefore a playback section extending 5 seconds in either direction, from 16 seconds to 26 seconds, is extracted as the highlight scene. In FIG. 7B, a playback section starting at 16 seconds, which is 5 seconds before the playback position of the first mark (21 seconds), and ending at 28 seconds, which is 5 seconds after the playback position of the last mark (23 seconds) is extracted as a highlight scene.

Note that the setting of 5 seconds for the fixed length in FIG. 7 is only an example, and the fixed length is not limited to this value. Furthermore, the method of extracting a highlight scene is not limited to extraction of a fixed length. Any method may be used as long as the extracted highlight scene includes the mark playback position.

For example, a method such as the method disclosed in Patent Literature 3 may be used. With this method, a highlight scene is extracted by calculating and comparing image features for each frame in a playback section extending in either direction of the mark playback position, and using, as cutoffs for the highlight scene, frames in the playback section in either direction of the mark playback position for which a difference in the image features is at least a threshold value.

Scenes may also be extracted with the following method. The frames in either direction of the mark playback position are subdivided from the perspective of sound. Features related to the sound environment are then derived for each subdivision, and an average value is calculated. The frames for which the difference between the features and the average value is at least a threshold value are used as cutoffs for the scene.

Furthermore, a method such as the method disclosed in Patent Literature 4 may be used. With this method, when an operation of the filming device that the user uses when filming the frames in the playback section extending in either direction of the mark playback position is a particular operation, a highlight scene is extracted using frames for which the particular operation was performed as cutoffs for the highlight scene.

The method of extracting highlight scene is not limited to the above examples.

### Highlight Scene Priority Degree Providing Step

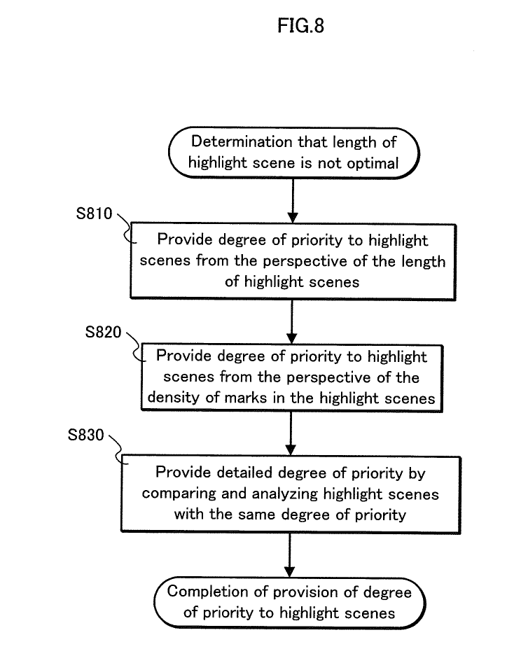

Next, details on the highlight scene priority degree providing step (S340) are provided with reference to FIG. 8.

First, the priority degree providing unit 16 provides a degree of priority from the perspective of the “length of the playback section of a highlight scene” (S810).

Since the user wishes to see a highlight video that is a condensation of scenes the user found interesting, it is necessary for the length of the playback section of a highlight scene not to be too long, but rather “long enough to appear interesting”. Therefore, the degree of priority of a scene that is clearly too short or too long is lowered.

Specifically, two indices T1 and T2 (T1<T2) are introduced for the length of the playback section of a highlight scene. The degree of priority of the highlight scene is lowest when the length of the playback section is shorter than T1 or longer than T2. Note that this method is only an example, and provision of degrees of priority is not limited in this way.

Here, “T1” represents the minimum length for perceiving the highlight scene as interesting. “T2” is the maximum length for which the highlight scene is enjoyable without becoming tiring.

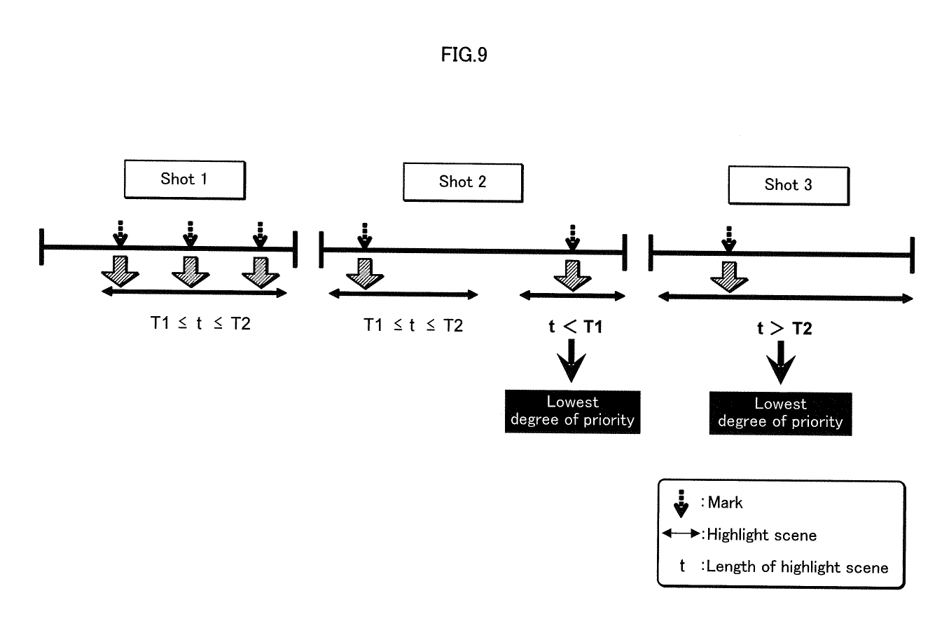

FIG. 9 shows an example of providing degrees of priority based on the length of the playback section of highlight scenes. In this example, the highlight scene extracted from the second mark in shot 2 is determined to have the lowest degree of priority, since the length of the playback section is shorter than T1. The highlight scene extracted in shot 3 is similarly determined to have the lowest degree of priority, since the length of the playback section is longer than T2.

Next, the priority degree providing unit 16 provides degrees of priority to the highlight scenes for which the length in step S810 was at least T1 and at most T2, from the perspective of “density of marks in the highlight scene” (S820).

The following describes an example of providing degrees of priority based on the “density of marks in the highlight scene” in detail. The density of marks refers to the number of marks in one highlight scene.

A “highlight scene that includes a plurality of highlights” is interesting when viewed continually, even if the scene is slightly long. Therefore, the degree of priority of a highlight scene is raised when the density of marks in the highlight scene is high. In other words, the priority degree providing unit 16 raises the degree of priority when the number of marks in one highlight scene is large and lowers the degree of priority when the number of marks in one highlight scene is small.

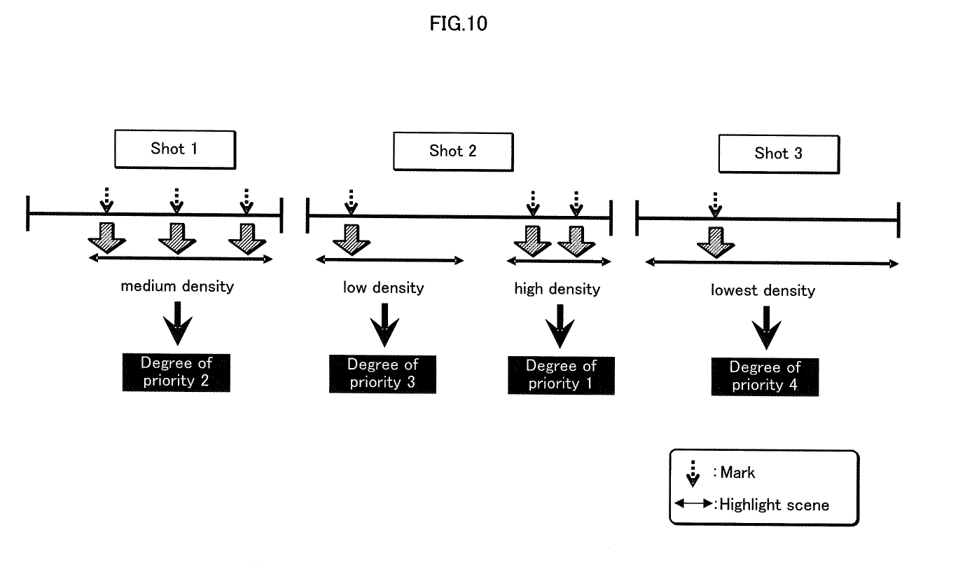

FIG. 10 shows an example of providing degrees of priority based on the density of marks in the highlight scenes. In this example, since the density of marks in the extracted highlight scene to the right in shot 2 is high, the highlight scene is determined to have degree of priority 1, which is the highest degree of priority. Next, since the density of marks in the extracted highlight scene in shot 1 is a medium density, the highlight scene is determined to have degree of priority 2. Furthermore, since the density of marks in the extracted highlight scene to the left in shot 2 is low, the highlight scene is determined to have degree of priority 3. Finally, since the density of marks in the extracted highlight scene in shot 3 is lowest, the highlight scene is determined to have degree of priority 4. Note that the number of marks per unit of time in each highlight scene may be used as the density of marks.

Finally, the priority degree providing unit 16 provides detailed degrees of priority by comparing and analyzing highlight scenes having the same degree of priority as a result of steps S810 and S820 (S830). For example, the following methods offer ways of providing detailed degrees of priority.
The degree of priority of a highlight scene in which a particular image is included is raised (example: highlight scene including a child's facial image)
The degree of priority of a highlight scene in which a particular sound is included is raised (example: highlight scene including a child's song)
The degree of priority of a highlight scene for which a particular operation is performed during filming is raised (example: highlight scene immediately after a zoom)
The degree of priority of a highlight scene assumed to have been filmed unsuccessfully is lowered (example: highlight scene during which the camera shakes noticeably)
The degree of priority of a highlight scene that includes particular metadata is raised (example: highlight scene during which a still image is photographed)

Using methods such as these to provide detailed degrees of priority allows for provision of degrees of priority that reflect the user's subjective perception of the highlight scenes.

All of the above methods for providing detailed degrees of priority to the highlight scenes, or a plurality thereof, may be selected and used to assign points to highlight scenes, and degrees of priority may be provided based on the assigned points. Furthermore, when confirming the length of the highlight video in step S330, it may also be confirmed whether the highlight video is too long or too short as compared with a preset time, and in each case, a different method for providing degrees of priority may be used.

### Highlight Scene Length Adjustment Step

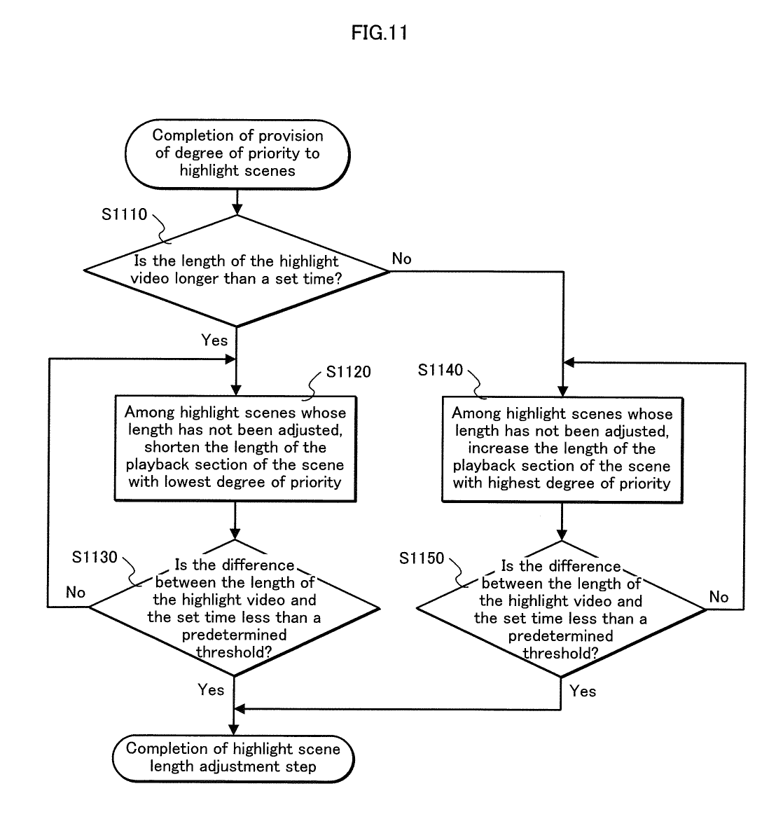

Finally, the highlight scene length adjustment step (S350) is described with reference to FIG. 11.

Upon completion of step S340, the priority degree providing unit 16 notifies the highlight scene video creation unit 18. Upon receiving the notification, the length adjustment unit 20 in the highlight video creation unit 18 confirms whether the length of the highlight video is longer than a set time (S1110).

When the length of the highlight video is longer than the set time (S1110: Yes), the length adjustment unit 20 issues a request to the highlight scene extraction unit 14 to re-extract a highlight scene so that the highlight scene is shorter.

Having received the request, the highlight scene extraction unit 14 extracts highlight scenes, from among all of the extracted highlight scenes, for which the length has not yet been adjusted and shortens the length of the playback section of the highlight scene having the lowest degree of priority among the extracted highlight scenes (S1120).

One method for shortening the length of the playback section of a highlight scene based on such a re-extraction request is for the highlight scene extraction unit 14 to re-extract the highlight scene using the algorithm used in the first extraction (S320), changing the parameters so that the playback section of the highlight scene is shorter.

For example, if the method used in the first extraction (S320) is to extract, as a highlight scene, the playback section extending for a set fixed length in either direction from the mark playback position, then the fixed length may be made shorter than in the first extraction. Specifically, the fixed length set to 5 seconds in FIG. 7 is shortened to 3 seconds.

On the other hand, if the method used in the first extraction (S320) is to analyze image features or features of the sound environment, parameters such as the threshold for comparing the difference in features between images may be adjusted so that extracting the playback section in either direction of the mark playback position as the playback section yields a shorter highlight scene than the first extracted highlight scene (S320).

Furthermore, if the method used in the first extraction (S320) is to analyze operations of the filming device, the scene cutoff that is closer to the mark playback position may be used as is as the starting point of the highlight scene, and the end of the highlight scene may be set so as to include the mark playback position and so that the highlight scene becomes shorter than the highlight scene extracted in step S320.

Note that based on the re-extraction request, the method for shortening the length of the playback section of the highlight scene may be to use a different method than the algorithm used during the first extraction (S320). The method of shortening the playback section of the highlight scene is not limited to the above methods.

Furthermore, in step S1120, among highlight scenes provided with the lowest degree of priority, a highlight scene having a playback section that is too short, i.e. shorter than T1, may be excluded from adjustment, or the playback section of the highlight scene may be lengthened.

Next, when the processing to shorten one highlight scene in step S1120 is complete, the highlight video creation unit 18 determines whether the difference between the length of the entire highlight video and the set time is less than a predetermined threshold (S1130). If the difference is less than the threshold, the highlight scene length adjustment step is complete. On the other hand, if the difference is equal to or greater than the threshold, processing returns to step S1120, and the length adjustment unit 20 issues a request to the highlight scene extraction unit 14 to re-extract a highlight scene so that the highlight scene is shorter. Having received the request, the highlight scene extraction unit 14 extracts highlight scenes, from among all of the extracted highlight scenes, for which the length has not yet been adjusted and shortens the length of the playback section of the highlight scene having the lowest degree of priority among the extracted highlight scenes.

On the other hand, if the length is shorter than the set time in the comparison in step S1110, the length adjustment unit 20 issues a request to the highlight scene extraction unit 14 to re-extract a highlight scene so that the highlight scene is longer. First, having receiving the request, the highlight scene extraction unit 14 increases the length of the playback section of the scene having the highest degree of priority among highlight scenes whose length has not been adjusted (S1140). As with the method for shortening the highlight scene in step S1120, the method for lengthening the playback section of the highlight scene may be a similar method to the method used to extract the highlight scenes in the highlight scene extraction step (S320), or a different method may be used.

Note that in step S1140, among highlight scenes provided with the lowest degree of priority, a highlight scene having a playback section that is longer than T2 may be excluded from adjustment, or the playback section of the highlight scene may be shortened.

Upon shortening one highlight scene, the length adjustment unit 20 determines whether the difference between the length of the highlight video and the set time is less than the predetermined threshold (S1150). If the difference is within the threshold (S1150: Yes), the highlight scene length adjustment step is complete. On the other hand, if the difference is equal to or greater than the threshold (S1150: No), processing returns to step S1140, and the playback section of the highlight scene having the next highest degree of priority is lengthened.

In the present embodiment, as described above, the length of the playback section of the highlight scenes is adjusted based on the degree of priority provided to the highlight scenes so as to create a highlight video that is based on a preset time and is in line with the user's preferences.

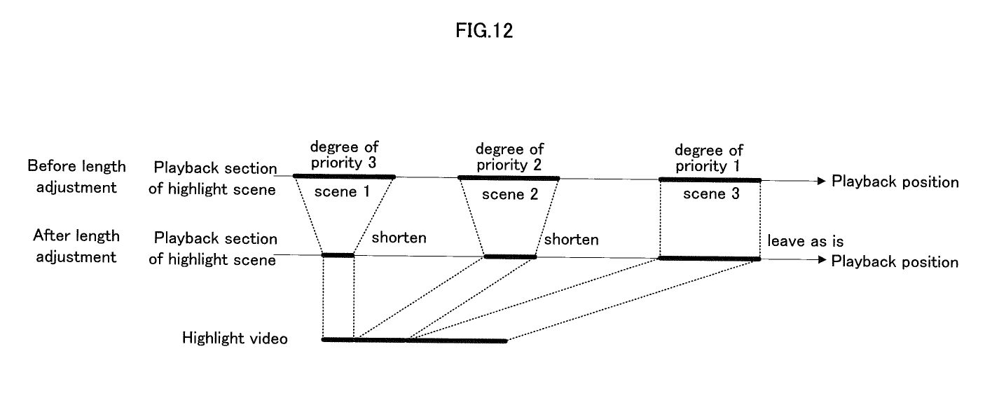

For example, as shown in FIG. 12, if the highlight video yielded by connecting scenes 1 through 3, which are extracted as highlight scenes, exceeds a preset time, the length of the highlight video can be adjusted to fall within the preset time by reducing the length of scenes 1 and 2, which have a low degree of priority (i.e. are assumed to have a low degree of importance to the user).

The present embodiment allows a user easily to create a highlight video in line with the user's preferences, therefore also contributing to prevention of long-term storage of content that is not used.

### Embodiment 2

The present embodiment is an application of Embodiment 1. Among other differences, Embodiment 2 differs from Embodiment 1 by using a sound analysis method for highlight scene extraction and by taking the relationship between scenes into consideration when providing degrees of priority. A description of similarities with Embodiment 1 is omitted.

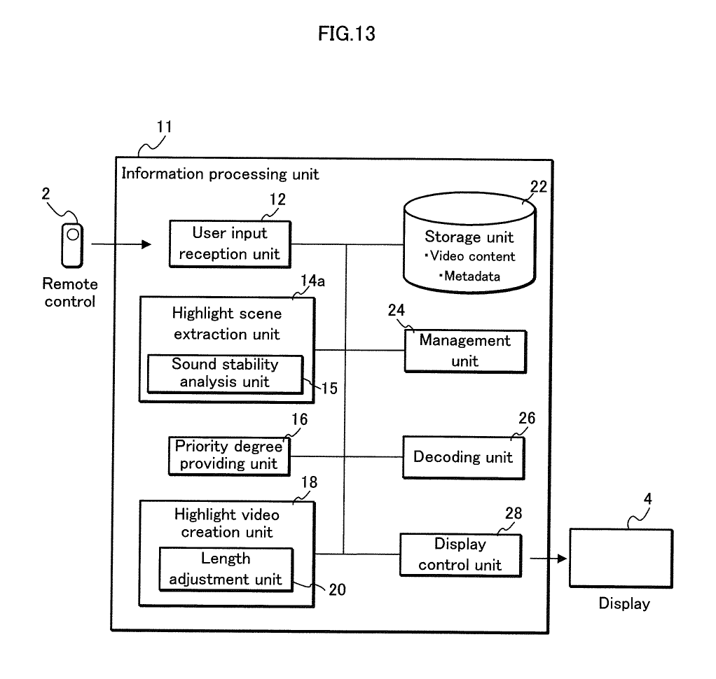

The information processing device 11 in FIG. 13 differs from FIG. 1 in that a highlight scene extraction unit 14a includes a sound stability analysis unit 15.

The sound stability analysis unit 15 has a function to analyze the sound stability of a video content.

### Highlight Scene Extraction Step

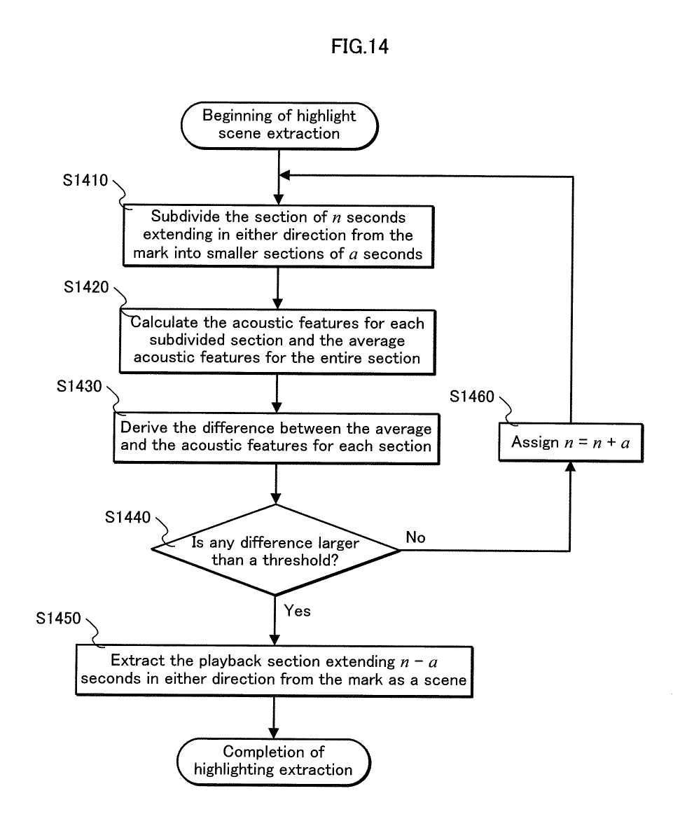

Next, the method of highlight scene extraction in Embodiment 2 is described with reference to FIG. 14.

The highlight scene extraction unit 14a extracts a section of n seconds extending in either direction from the mark playback position and issues a request to the sound stability analysis unit 15 to analyze the sound stability.

The sound stability analysis unit 15 subdivides the section of n seconds into minimum sections of a seconds (a being any positive number) (S1410).

When a highlight scene is being extracted for the first time for a mark playback position, n is a predetermined minimum value. Otherwise, n is a value designated in step S1460, described below. The minimum section of a seconds may be a value predetermined by the information processing device 11, a value set by the user, or a value that changes dynamically in accordance with other conditions.

Next, the sound stability analysis unit 15 calculates the acoustic features for each subdivided section and derives the average acoustic features for the entire section (S1420).

Subsequently, based on the result of the derivation in step S1420 by the sound stability analysis unit 15 located in the highlight scene extraction unit 14a, the highlight scene extraction unit 14a derives the difference between the average and the acoustic features for each section (S1430).

Next, the highlight scene extraction unit 14a determines whether any of the derived differences is larger than a predetermined threshold (S1440). If one of the differences is larger, the highlight scene extraction unit 14a sets n=n+a and repeats processing from step S1410 (S1460). If one of the differences is larger, the section extending n−a seconds in either direction from the mark is extracted as a scene (S1450).

It can be said that the amount of change in the acoustic features within the extracted highlight scene is small, and therefore that the sound stability is high. Generally, the change in sound stability and the change in conditions within a scene are often related, and therefore the present method allows for extraction of a scene that is meaningful to the user.

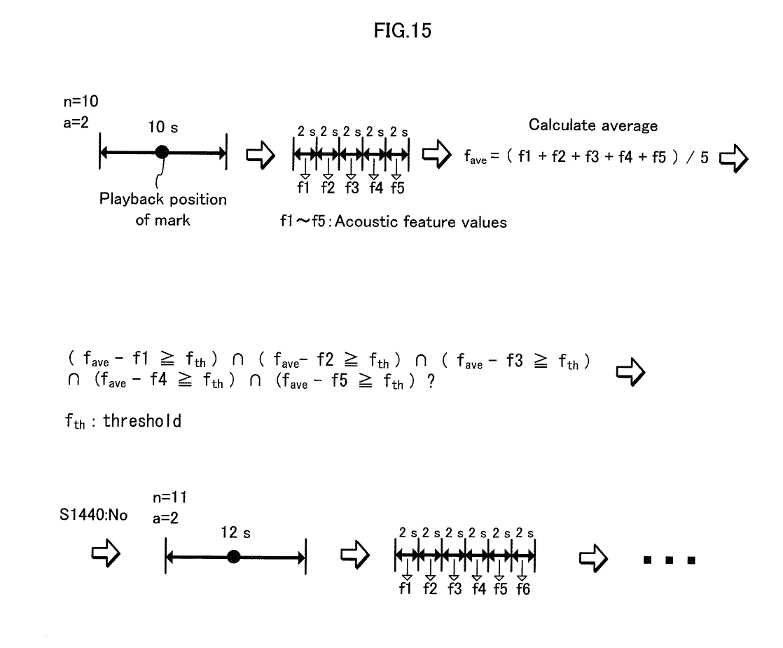

FIG. 15 shows an example of the highlight scene extraction step.

In the example in FIG. 15, n=10, a=2, and a section extending 10 seconds in either direction from the mark playback position is subdivided into two-second long sections. For each subdivided section, acoustic features f1 through f5 and an average of the acoustic features fₐᵥₑ=(f1+f2+f3+f4+f5)/5 is calculated.

Furthermore, FIG. 15 shows how the difference between each of the acoustic features f1 through f5 and the average fₐᵥₑ is compared with a predetermined threshold fₜₕ. Since none of the differences is larger than the threshold fₜₕ (S1440: No), the extracted section is lengthened from 10 seconds to 12 seconds. The threshold fₜₕ has been described as a predetermined value but is not limited in this way. Alternatively, the threshold fₜₕ may be a value set by the user or a value that changes dynamically in accordance with other conditions.

Note that the processing shown in FIG. 14 is only one example. Any method for analyzing the acoustic features in either direction of the playback position and extracting, as a scene, a section in which the analyzed acoustic features are similar is acceptable.

### Highlight Scene Priority Degree Providing Step

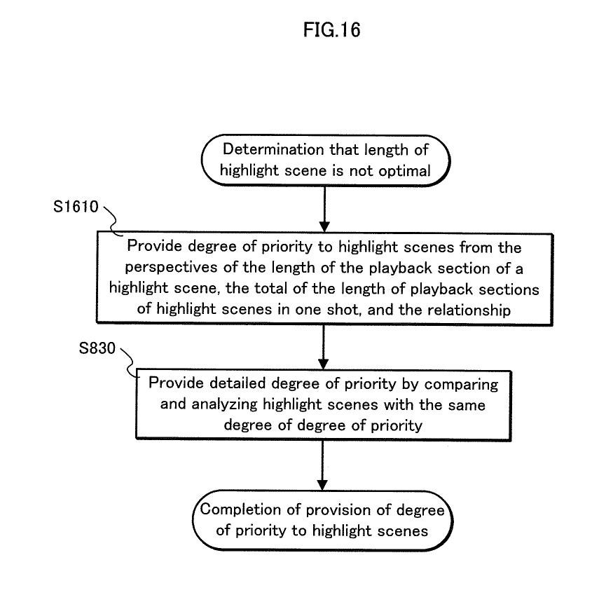

The following describes details on the highlight scene priority degree providing step (S340) in Embodiment 2 with reference to FIG. 16.

The priority degree providing unit 16 provides degrees of priority from the perspectives of “the length of the playback section of a highlight scene”, “the total of the length of playback sections of highlight scenes in one shot”, and “the relationship between highlight scenes in one shot” (S1610).

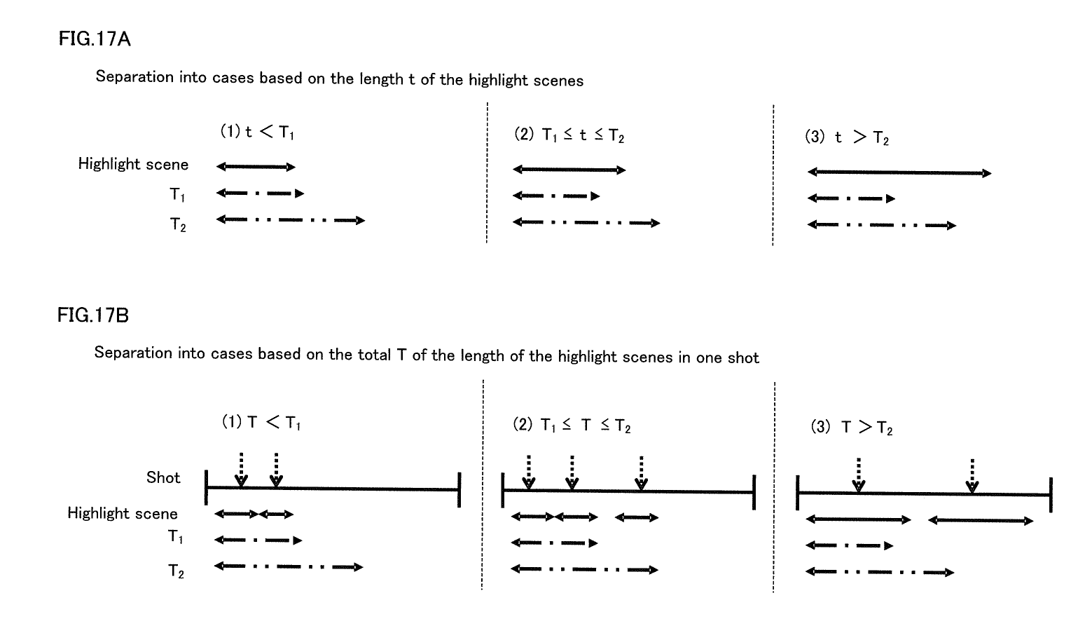

An example is shown of the method for providing degrees of priority in step S1610. First, details are provided on a method of providing degrees of priority based on the “length of the playback section of a highlight scene”. Since the user wishes to see a highlight video that is a condensation of scenes the user found interesting, it is necessary for the length of the playback section of a highlight scene not to be too long, but rather “long enough to appear interesting”. Therefore, the degree of priority of a scene that is clearly too short or too long needs to be lowered. Two indices T1 and T2 are thus introduced for the length of the playback section of a highlight scene. T1 is the “minimum length of the playback section of a highlight scene in order for the highlight scene to be perceived as interesting”. T2 is the “maximum length of the playback section of a highlight scene in order for the highlight scene to be enjoyable without becoming tiring”. Degrees of priority are provided to a highlight scene for different cases based on these two indices. First, the method of providing degrees of priority based on the “length of the playback section of a highlight scene” is described. As shown in FIG. 17A, in the case when the length t of the playback section of a highlight scene is less than T1, i.e. t<T1, the degree of priority is lowered, since the playback section of the highlight scene is too short. In the case when T1≦t≦T2, the length of the playback section of the highlight scene is optimal, and therefore the degree of priority is raised. In the case when t>T2, the playback section of the highlight scene is too long, and therefore the degree of priority is lowered.

Next, the method of providing degrees of priority based on the “the total of the length of playback sections of highlight scenes in one shot” is described. An “extracted scene that includes a plurality of highlights” is interesting when viewed continually, even if the scene is slightly long. The degree of priority that is provided therefore also varies based on the indices T1 and T2 with respect to the total length of the playback section of a plurality of highly related highlight scenes within one shot. FIG. 17B shows separation into cases based on the total T of the length of the playback sections of the highlight scenes in one shot. First, in the case when the total T of the length of the playback sections of the highlight scenes in one shot is less than T1, i.e. T<T1, the degree of priority is lowered, since the playback sections are too short. In the case when T1≦T≦T2, the length of the playback sections is optimal, and therefore the degree of priority is raised. In the case when T>T2, the playback sections are too long, and therefore the degree of priority is lowered.

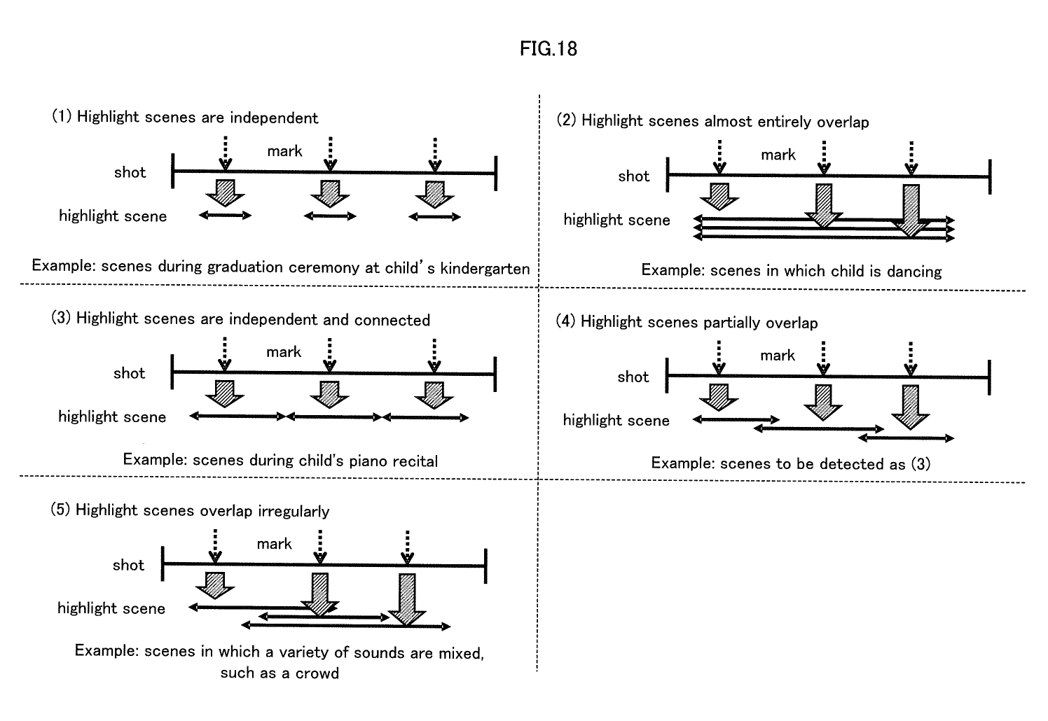

Next, the “relationship between highlight scenes in one shot” is described in detail. Generally, users film one shot as one cohesive unit. Therefore, a plurality of scenes extracted from one shot are often highly related. Provision of the degree of priority is separated into cases taking this relationship into consideration. FIG. 18 shows the relationship between a plurality of highlight scenes in one shot.

Note that FIG. 18 only shows an example, and the relationship is not limited in this way.

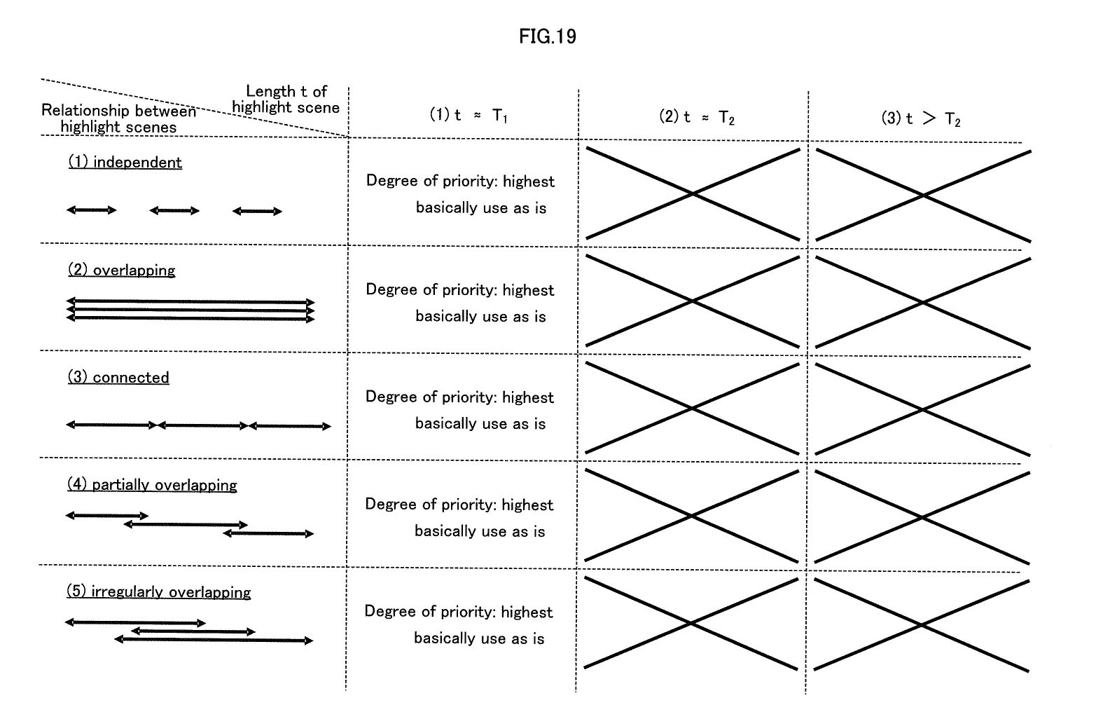

The priority degree providing unit 16 sets the degree of priority of a highlight scene by comprehensively taking into consideration the length of the playback section of each highlight scene, the total length, and the relationship between highlight scenes within one shot. FIGS. 19 through 21 illustrate methods by which the priority degree providing unit 16 sets the degree of priority of highlight scenes based on the above determination factors. Note that FIGS. 19 through 21 only show an example, and methods are not limited in this way.

First, the priority degree providing unit 16 checks the total T of the length of playback sections of highlight scenes in one shot and subsequently checks the relationship with the length of the playback section of each highlight scene.

In the case when T≈T1 and t≈T1, as in FIG. 19, the degree of priority is set to be the highest, and the scenes are basically used as highlight scenes without modification, since the total of the length of playback sections of highlight scenes, as well as the length of each scene, is near the lower limit of the optimal length of the playback section of a highlight scene.

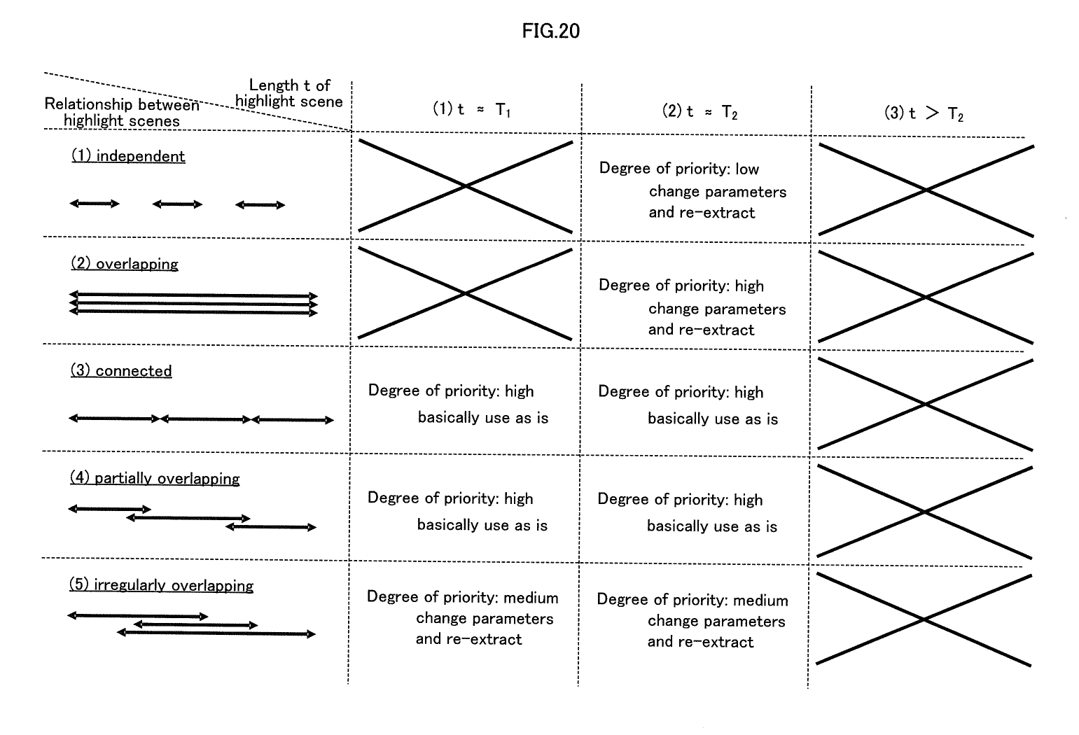

Next, when T≈T2, as in FIG. 20, the degree of priority is changed based on the length of the playback section of the highlight scenes and on the relationship therebetween. For example, if the highlight scenes have an irregular relationship, it is determined that the highlight scenes can neither be considered closely nor loosely related. The degree of priority is thus set to medium. When t≈T2 and the highlight scenes are independent, it is determined that the scenes are only loosely related and that there is a good deal of room for shortening the highlight scenes. The degree of priority is thus set to be low. In other cases, it is determined that the highlight scenes are optimal, or that there is no room to further shorten the highlight scenes. The degree of priority is thus set to be high.

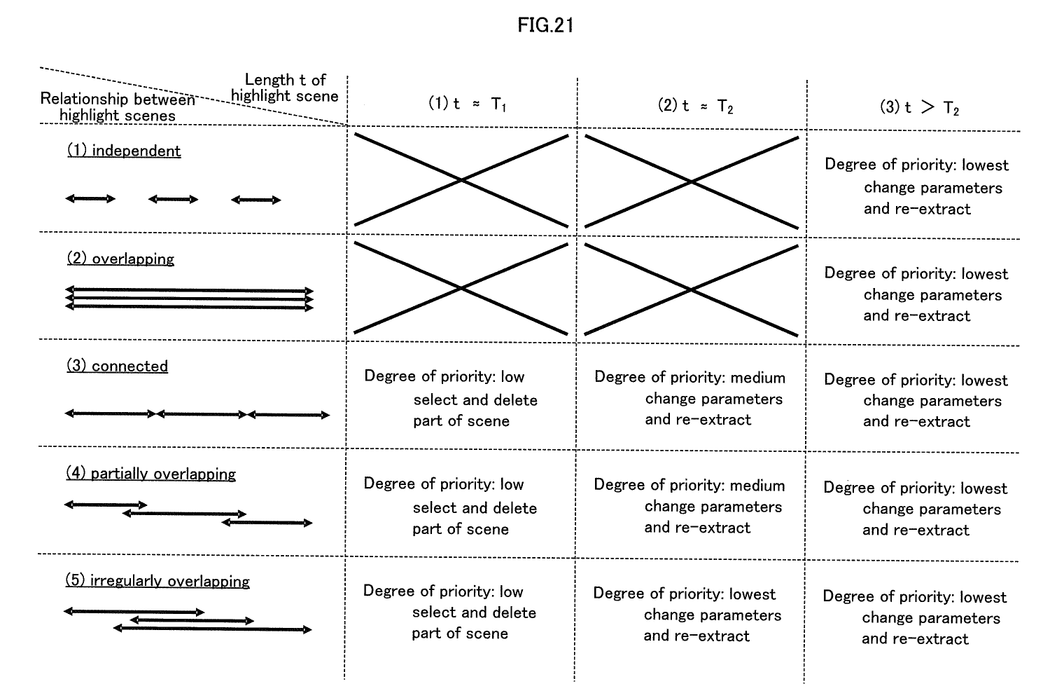

Next, when T>T2 as in FIG. 21, it is determined that the highlight scene is too long, and the degree of priority is basically set to be low. However, when the relationship between highlight scenes is “connected” or “partial overlap”, it is more likely that the scene is an “extracted scene that includes a number of highlights”, and therefore the degree of priority is set to medium.

Finally, the information processing device 11 provides detailed degrees of priority by comparing and analyzing highlight scenes having the same degree of priority as a result of step S1610 (S830). Since step S830 is the same as step S830 in Embodiment 1, details are omitted.

This method of providing degrees of priority in Embodiment 2 allows for provision of an appropriate degree of priority more flexibly based on the length of a highlight scene and on the relationship between highlight scenes. When shortening highlight scenes, for example, this allows for a reduction, insofar as possible, in the probability of shortening a scene that is expected to be important for the user.

### Highlight Scene Length Adjustment Step

This processing is for adjusting the length of each highlight scene based on the provided degrees of priority. As this processing is the same as Embodiment 1 (FIG. 11), a description thereof is omitted.

### Embodiment 3

In Embodiment 1, marks are associated with the video based on input by the user operating the remote control 2, but the association of marks is not limited in this way. Embodiment 3 introduces another method for providing a video with marks.

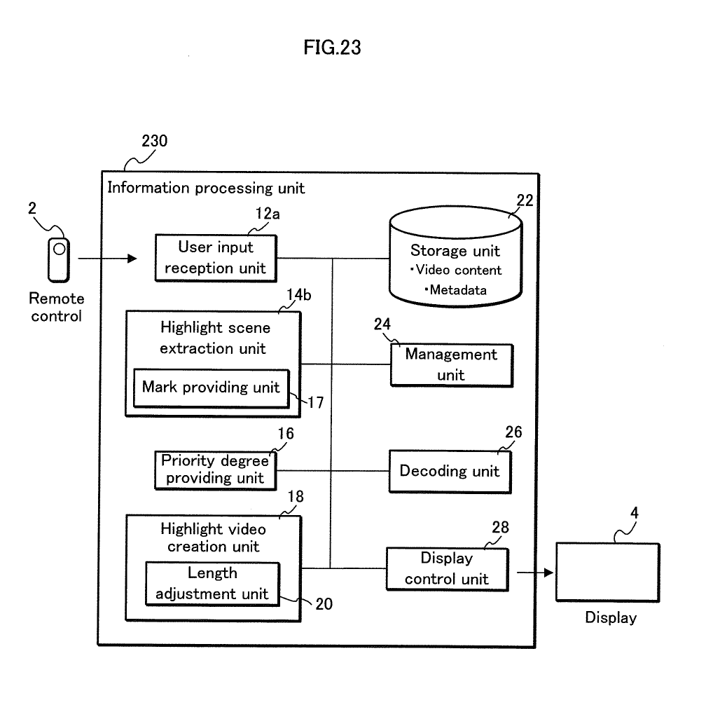

An information processing device 230 in FIG. 23 is, in particular, provided with a user input reception unit 12a and a highlight scene extraction unit 14b that includes a mark providing unit 17. Other function blocks are basically similar to FIG. 1, and therefore a description thereof is omitted.

The user input reception unit 12a receives an instruction to play back a video, yet unlike Embodiment 1, need not receive the input operation for providing marks.

The opportunity for the mark providing unit 17 to provide marks is not particularly limited. For example, the mark providing unit may provide marks upon the start of highlight scene extraction by the highlight scene extraction unit 14b.

Based on the mark playback positions provided by the mark providing unit 17, the highlight scene extraction unit 14b extracts highlight scenes from the video content. The opportunity for the highlight scene extraction unit 14 to extract highlight scenes may, for example, be the following opportunities (A) and (B).

(A) When video content is loaded into the storage unit 22

(B) When the user indicates to play back a highlight video

Based on the mark playback positions provided by the mark providing unit 17, the highlight scene extraction unit 14b extracts highlight scenes from the video content.

The relationship between these blocks is now described in detail. The mark providing unit 17 provides marks to a video content based on one index or a combination of a plurality of indices. Subsequently, the mark providing unit 17 causes the storage unit 22 to store metadata that includes the provided mark playback positions. The structure of the metadata is the same as FIG. 2, and therefore a description thereof is omitted. Based on the mark playback positions included in the metadata stored in the storage unit 22, the highlight scene extraction unit 14b extracts highlight scenes from the video content.

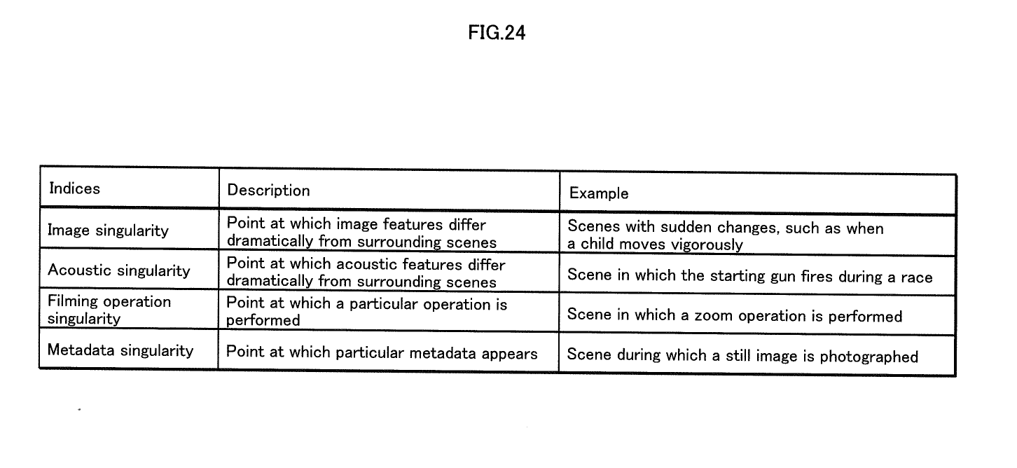

FIG. 24 shows an example of indices used by the mark providing unit 17.

An image singularity index is for providing a mark to a point (playback position) at which an image features differ dramatically from surrounding points. Examples of such an image singularity index are a movement vector of an object in an image, the color features in an image, or the like. For example, the mark providing unit 17 provides a mark when the difference in the movement vectors as compared to surrounding scenes exceeds a threshold.

An acoustic singularity is for providing a mark to a point at which the acoustic features differ dramatically from surrounding points. For example, the acoustic features may be calculated for each section within the video content in advance, and the mark providing unit 17 may provide a mark when the difference between the acoustic features of adjacent sections is at least a threshold.

A filming operation singularity is for providing a mark to a point at which a particular operation is performed. For example, if a zoom operation is being performed, it can be assumed that the shooter finds the scene interesting, and therefore the mark providing unit 17 may provide a mark at the playback position when the zoom operation begins.

A metadata singularity is for providing a mark to a point at which particular metadata appears. An example of such metadata is still image photography during video filming. In this case, the mark providing unit 17 provides a mark to the playback position at which the still image is photographed.

After the mark providing unit 17 provides marks with the above methods, the highlight scene extraction unit 14b extracts highlight scenes based on the provided marks. Note that the highlight scene extraction step (S320) that uses the marks provided by the mark providing unit 19 may use the same method as described in Embodiment 1, and therefore a description is omitted here. The same methods as described in Embodiment 1 may also be used for the subsequent highlight scene priority degree providing step (S340) and the highlight scene length adjustment step (S350), and therefore a description is omitted here.

### Embodiment 4

In Embodiment 4, another form of the mark providing unit illustrated in Embodiment 3 is described.

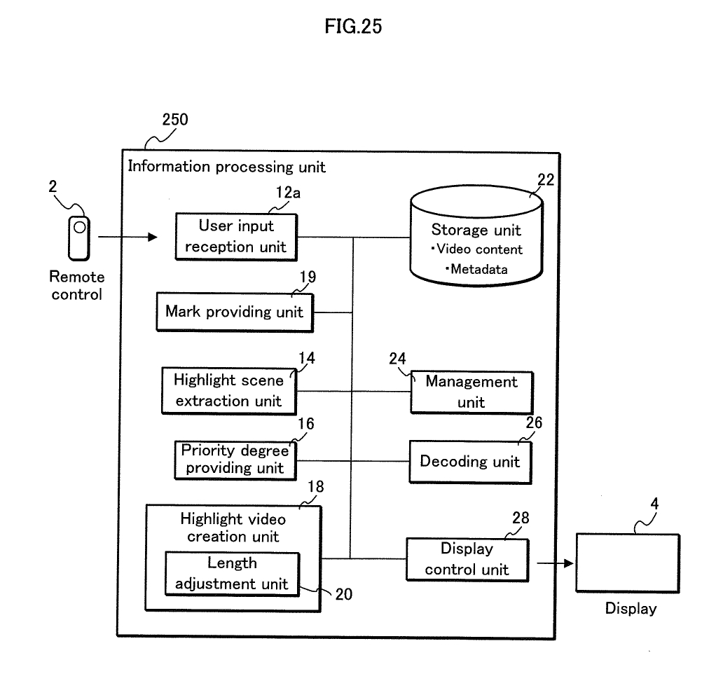

In the information processing device 230 in FIG. 23, the mark providing unit 17 is included in the highlight scene extraction unit 14b, but the mark providing unit 17 may be independent from the highlight scene extraction unit 14b. Such an information processing device 250 is shown in FIG. 25.

The information processing device 250 in FIG. 25 is, in particular, provided with a user input reception unit 12a and a mark providing unit 19.

The user input reception unit 12a receives instructions via the remote control 2, such as an instruction to play back a highlight video.

The mark providing unit 19 provides marks to a video content based on one index or a combination of a plurality of indices. The method of provision is similar to the method described for the mark providing unit 17.

The opportunities for the mark providing unit 19 to provide marks are similar to the opportunities for the mark providing unit 17. For example, marks may be provided automatically in the following cases.

(A) When video content is loaded into the storage unit 22, or

(B) When the user indicates to play back a highlight video

With Embodiment 4, instead of providing marks and extracting highlight scenes simultaneously, marks can be provided in advance, and the provided marks can be used for later extraction of highlight scenes or for other purposes.

For example, this approach is useful when processing to automatically provide marks is time consuming due to constraints on device specifications.

Note that the highlight scene extraction step (S320) that uses the marks provided by the mark providing unit 19, the subsequent highlight scene priority degree providing step (S340), and the highlight scene length adjustment step (S350) may use the same method as described in Embodiment 1, and therefore a description is omitted here.

In Embodiment 4, the highlight scene extraction by the highlight scene extraction unit 14 (including highlight scene re-extraction in response to a request from the highlight video creation unit 18) and provision of marks by the mark providing unit 19 are performed independently. Both the highlight scene extraction unit 14 and the mark providing unit 19, however, perform the same content analysis. Therefore, for example, the information processing device 250 may be provided with a content analysis unit not shown in the figures. When performing processing, the highlight scene extraction unit 14 and the mark providing unit 19 may issue a request to the content analysis unit to analyze the content and use the result for highlight scene extraction or provision of marks.

### Supplementary Explanation 1

Although embodiments of the present invention have been described, it is to be understood that the present invention is not limited thereto. The present invention may be embodied in a variety of ways, such as those described below, for achieving the aim of the present invention or other aims related or associated thereto.

(1) Input Device

While the remote control 2 has been described as an example of the input device in each embodiment, the input device is not limited in this way. It suffices for the input device to allow for the user to search for a playback position that the user wishes to highlight. For example, the following type of input device is possible.

The input device may, for example, be a mouse and keyboard.

When the information processing device is provided with a touch panel, the input device may also be a stylus, such as a touch pen, or the user's finger.

Furthermore, when the information processing device is provided with a microphone and a voice recognition function, input may be accepted by voice. Alternatively, when the information processing device is provided with a function to recognize a human body model, such as a palm, input may be accepted by gesture.

(2) Optimal Range for Highlight Scene

The optimal length for a highlight scene in step S330 in FIG. 3 may, for example, be a state in which the difference between a length pre-registered in the information processing device 10 and the length of the highlight scene is equal to or less than a predetermined value, or a state in which the length of the highlight scene is longer or shorter than a registered length. Furthermore, a length input by the user may be used instead of the registered length.

Alternatively, judgment may be deferred to the user by asking the user whether the length of the highlight scene is optimal.

(3) Method of Providing Degrees of Priority

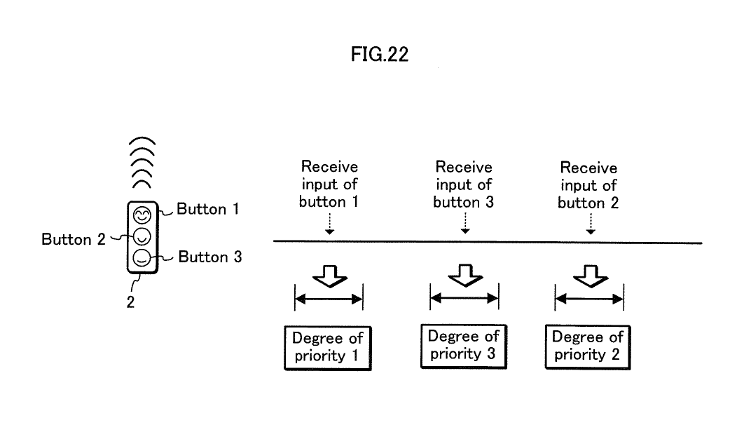

As the method of providing degrees of priority, a remote control 2 as shown in FIG. 22 may be used. Specifically, the remote control 2 includes a button 1 indicating the highest degree of priority, a button 2 indicating a medium degree of priority, and a button 3 indicating the lowest degree of priority. The priority degree providing unit 16 may provide a certain degree of priority 1-3 in accordance with the button 1-3 received by the user input reception unit 12.

(4) Integrated Circuit

The information processing device of the embodiment may be implemented as an integrated circuit, typically as a Large Scale Integration (LSI). Each of the circuits may be separately integrated into a single chip, or the circuits may be integrated into a single chip including a part or all of the circuits. Although referred to here as an LSI, depending on the degree of integration, the terms IC (Integrated Circuit), system LSI, super LSI, or ultra LSI are also used. In addition, the method for assembling integrated circuits is not limited to a LSI, and a dedicated communication circuit or a general-purpose processor may be used. An FPGA (Field Programmable Gate Array), which is programmable after the LSI is manufactured, or a reconfigurable processor, which allows reconfiguration of the connection and setting of circuit cells inside the LSI, may be used.

Furthermore, if technology for forming integrated circuits that replaces LSIs emerges, owing to advances in semiconductor technology or to another derivative technology, the integration of functional blocks may naturally be accomplished using such technology. The application of biotechnology or the like is possible.

(5) Recording Medium, Program

It is possible to distribute a control program composed of program code for causing processors of various devices, including computers, and various circuits connected to the processors to execute the processing described in the embodiments. The distribution of such a control program may be realized by recording the control program onto recording media, or by transmission via various communication channels.

The recording media which may be used in the distribution of the control program include a Smart Media, a Compact Flash™, a Memory Stick™, an SD memory card, a multimedia card, a CD-R/RW, a DVD±R/RW, a DVD-RAM, an HD-DVD, a BD (Blu-ray Disc), and the like.

The distributed control program is used by being stored on a processor-readable memory or the like and executed by the processor in order to achieve the various functions described in the embodiments.

(6) Adjustment of the Length of a Highlight Scene

In the embodiments, adjustment of the length of a highlight scene is made by the length adjustment unit 20 requesting that the highlight extraction unit 14 re-extract a highlight scene so as to have a different length, but adjustment is not limited in this way. For example, the length adjustment unit 20 may directly adjust the length of a highlight scene. In this case, the length adjustment unit 20 directly performs the processing performed by the highlight scene extraction unit 14.

For example, a first method may be adopted, whereby the same algorithm as in the first extraction (S320) is used for re-extraction by changing the parameters so that the playback section of the highlight scene becomes shorter. Alternatively, a second method may be adopted, whereby the highlight scene extraction unit 14 uses a different algorithm from the first extraction (S320) to re-extract the highlight scene so that the playback section of the highlight scene becomes shorter. The method of shortening the playback section of the highlight scene is not limited to the above methods.

(7) Provision of the Degrees of Priority Based on Density of Marks or on Other Factors

A higher or lower degree of priority may be provided to a highlight scene based on whether marks are concentrated or sparse along the playback time axis.

The index for determining whether marks are “sparse” or “concentrated” may be the index of the density of marks per unit of time. In fact, even if the density is low when considered over a long period of time, it may be appropriate to provide a high degree of priority if marks are locally concentrated. Such a degree of local concentration of marks may also be used as an index.

Examples of methods for providing degrees of priority from this perspective include methods 1 to 3 below.

Method 1

Method 1 is to provide a degree of priority to a highlight scene based on the density of marks in the highlight scene, as described in Embodiment 1.

Method 2

Method 2 is to calculate the number of marks per unit of time by dividing the number of marks in one highlight scene by the length of the highlight scene, and then to provide a degree of priority to the highlight scene based on the result.

Method 3

Method 3 is to use the degree of local concentration of marks. Specifically, a degree of priority is provided to a highlight scene based on the maximum number of marks in a certain unit of time within the highlight scene, rather than throughout the entire highlight scene. As a result, even if the number of marks throughout the highlight scene is low, the above maximum number will increase if marks are concentrated in a certain unit of time (for example, one second), thus allowing for provision of a high degree of priority. Note that the above value of one second for the certain unit of time is only an example and is not limiting.

(8) Structure Necessary for Information Processing Device

In the embodiments, the highlight video is created within the information processing device, but such a creation function is not required. The highlight video may instead be created by another device. Furthermore, the function to store video content within the information processing device is not required, and video content stored in an external device may be used instead.

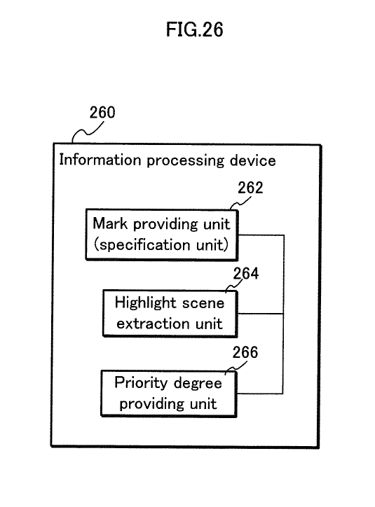

In other words, as shown in FIG. 26, it suffices as a general outline for an information processing device 260 to be provided with a mark providing unit (specification unit that specifies a playback position) 262 that provides a plurality of playback positions in a video content, a highlight extraction unit 264 that extracts, in accordance with the playback positions, a plurality of highlight scenes each including at least one of the playback positions and each indicating a section of the video content, and a priority provision unit 266 configured to provide a degree of priority to each of the extracted highlight scenes.

(9) Use of Degrees of Priority

In the embodiments, the description focuses on an example in which the assigned degrees of priority are used for creation of a highlight video, but the use of degrees of priority is not limited in this way.

For example, the assigned degrees of priority may be used to select and display highlight scenes with a high degree of priority among a plurality of video contents that are displayed on a screen as a list.

The user may also be informed of video content by displaying highlight scenes with a different color for each degree of priority on a menu screen that shows video content.

(10) Embodiments 1 through 4, as well as the contents of (1) through (9) in the Supplementary Explanation, may be combined.

### Supplementary Explanation 2

The above-described embodiments include the following aspects.

(1) An information processing device according to one aspect comprises a specification unit configured to specify a plurality of playback positions in a video content; an extraction unit configured to extract, in accordance with the specified playback positions, a plurality of scenes each including at least one of the specified playback positions and each indicating a section of the video content; and a provision unit configured to provide a degree of priority to each of the extracted scenes.

(2) In the information processing device of (1), the provision unit may analyze the specified playback positions to determine whether the specified playback positions are sparse or concentrated in each scene along a playback time axis, provide a low degree of priority to a scene in which the specified playback positions are determined to be sparse, and provide a high degree of priority to a scene in which the specified playback positions are determined to be concentrated.

(3) In the information processing device of (1), the provision unit may provide the degree of priority based on a length of each of the extracted scenes and a relationship between the extracted scenes along a playback time axis.

(4) In the information processing device of (1), the provision unit may analyze a count of playback positions in each of the extracted scenes, provide a high degree of priority to a scene with a high count of playback positions, and provide a low degree of priority to a scene with a low count of playback positions.

(5) In the information processing device of (1), the extraction unit may analyze acoustic feature values before and after each of the playback positions and extract the scenes so that each scene indicates a section having similar acoustic feature values.

This structure contributes to the extraction of a scene that can be expected to have meaning and cohesion.

(6) The information processing device of (1) may further comprise a creation unit configured to adjust a length of one or more of the extracted scenes in accordance with the degree of priority provided to each of the extracted scenes and to create a highlight video by connecting each of the extracted scenes after adjustment of the length of one or more of the extracted scenes by the adjustment unit.

(7) In the information processing device of (6), the creation unit may determine whether a length of the highlight video is within a predetermined range when all of the extracted scenes are connected, shorten a length of one of the extracted scenes having a low degree of priority when determining that the length of the highlight video exceeds an upper limit of the predetermined range, and extend a length of one of the extracted scenes having a high degree of priority when determining that the length of the highlight video is less than a lower limit of the predetermined range.

This structure allows for the length of the created highlight video to be set within the predetermined range.

(8) A highlight video creation method according to one aspect comprises the steps of: specifying a plurality of playback positions in a video content; extracting, in accordance with the specified playback positions, a plurality of scenes each including at least one of the specified playback positions and each indicating a section of the video content; and providing a degree of priority to each of the extracted scenes.

(9) A program according to one aspect is for causing an information processing device storing a video content to perform priority degree provision processing, the priority degree provision processing comprising the steps of: specifying a plurality of playback positions in a video content; extracting, in accordance with the specified playback positions, a plurality of scenes each including at least one of the specified playback positions and each indicating a section of the video content; and providing a degree of priority to each of the extracted scenes.

(10) An integrated circuit according to one aspect comprises: a specification unit configured to specify a plurality of playback positions in a video content; an extraction unit configured to extract, in accordance with the specified playback positions, a plurality of scenes each including at least one of the specified playback positions and each indicating a section of the video content; and a provision unit configured to provide a degree of priority to each of the extracted scenes.

### INDUSTRIAL APPLICABILITY

The information processing device of the present invention has a function to create a highlight video in accordance with user preference and is therefore useful as, for example, an information processing device for viewing video content.

### REFERENCE SIGNS LIST

2 remote control

4 display

10, 11, 230, 250, 260 information processing device

12 user input reception unit

14, 14a, 14b, 264 highlight scene extraction unit

15 sound stability analysis unit

16, 266 priority degree providing unit

17, 19 mark providing unit

18 highlight video creation unit

20 length adjustment unit

22 storage unit

24 management unit

26 decoding unit

28 display control unit

262 mark providing unit (specification unit)

1-10. (canceled)

11. An information processing device comprising:
a specification unit configured to specify a plurality of playback positions in a video content;
an extraction unit configured to extract, in accordance with the specified playback positions, a plurality of scenes each including at least one of the specified playback positions and each indicating a section of the video content;
a provision unit configured to provide a degree of priority to each of the extracted scenes; and
an adjustment unit configured to adjust a length of one or more of the extracted scenes in accordance with the degree of priority provided to each of the extracted scenes.

12. The information processing device of claim 11, wherein
the provision unit analyzes the specified playback positions to determine whether the specified playback positions are sparse or concentrated in each scene along a playback time axis, provides a low degree of priority to a scene in which the specified playback positions are determined to be sparse, and provides a high degree of priority to a scene in which the specified playback positions are determined to be concentrated.

13. The information processing device of claim 11, wherein
the provision unit provides the degree of priority based on a length of each of the extracted scenes and a relationship between the extracted scenes along a playback time axis.

14. The information processing device of claim 11, wherein
the provision unit analyzes a count of playback positions in each of the extracted scenes, provides a high degree of priority to a scene with a high count of playback positions, and provides a low degree of priority to a scene with a low count of playback positions.

15. The information processing device of claim 11, wherein
the extraction unit analyzes acoustic feature values before and after each of the playback positions and extracts the scenes so that each scene indicates a section having similar acoustic feature values.

16. The information processing device of claim 11, further comprising
a creation unit configured to create a highlight video by connecting each of the extracted scenes after adjustment of the length of one or more of the extracted scenes by the adjustment unit.

17. The information processing device of claim 16, wherein
the creation unit determines whether a length of the highlight video is within a predetermined range when all of the extracted scenes are connected, shortens a length of one of the extracted scenes having a low degree of priority when determining that the length of the highlight video exceeds an upper limit of the predetermined range, and extends a length of one of the extracted scenes having a high degree of priority when determining that the length of the highlight video is less than a lower limit of the predetermined range.

18. A highlight video creation method comprising the steps of:
specifying a plurality of playback positions in a video content;
extracting, in accordance with the specified playback positions, a plurality of scenes each including at least one of the specified playback positions and each indicating a section of the video content;
providing a degree of priority to each of the extracted scenes; and
adjusting a length of one or more of the extracted scenes in accordance with the degree of priority provided to each of the extracted scenes.

19. A program for causing an information processing device storing a video content to perform priority degree provision processing, the priority degree provision processing comprising the steps of:
specifying a plurality of playback positions in a video content;
extracting, in accordance with the specified playback positions, a plurality of scenes each including at least one of the specified playback positions and each indicating a section of the video content;
providing a degree of priority to each of the extracted scenes; and
adjusting a length of one or more of the extracted scenes in accordance with the degree of priority provided to each of the extracted scenes.

20. An integrated circuit comprising:
a specification unit configured to specify a plurality of playback positions in a video content;
an extraction unit configured to extract, in accordance with the specified playback positions, a plurality of scenes each including at least one of the specified playback positions and each indicating a section of the video content;
a provision unit configured to provide a degree of priority to each of the extracted scenes; and
an adjustment unit configured to adjust a length of one or more of the extracted scenes in accordance with the degree of priority provided to each of the extracted scenes.
